(19) United States
(12) Patent Application Publication
(10) Pub. No.: US 2007/0218885 A1
(43) Pub. Date: Sep. 20, 2007

(54) Method and apparatus for remote generation of a conference call using SMS or email messages

(75) Inventors: Gerald W. Pfleging, Batavia, IL (US); George Wilkin, Bolingbrook, IL (US)

Correspondence Address: Richard J. Minnich, Esq.;Fay, Sharpe, Fagan, Minnich & McKee, LLP, Seventh Floor, 1100 Superior Avenue, Cleveland, OH, 44114-2579, US

(73) Assignee: Lucent Technologies Inc.

(21) Appl. No.: 11/377,049

(22) Filed: Mar. 16, 2006

(51) Int. Cl. H04M 3/42

(52) U.S. Cl. 455/416

(57) ABSTRACT

A method and system for the remote generation of a conference call are provided. The method includes receiving an initiating transmission from a user establishing communication paths based on said initiating transmission and connecting the call paths to form a conference call. The initiating transmission can include, among other things, an e-mail or SMS message. The system will parse the message and generate the conference without the user being required to remember the company's access codes, the participant's contact information, etc.

### BACKGROUND OF THE DISCLOSURE

This disclosure relates to a method and apparatus for conference bridges, and more particularly, to the method and system for the remote generation of a conference call using a short message system (SMS) or email system.

While the disclosure is particularly directed to the art of remote generation of a conference bridge initiated through SMS or the like, and thus will be described with specific reference thereto, it will be appreciated that the disclosure may have other useful fields of application. For example, the disclosure may be used for establishing and securing parameters for editing of web based conference hosting.

By way of background, a telephone conference call is a call that allows three or more parties, each at separate locations, to connect with each other over a telecommunications device. Consumers and businesses often use these types of calls to arrange meetings where the participants in the meeting are separated by distance. Thus, telephone conferencing is a cost effective way in which all parties can meet in real time without requiring them to be in the same physical space.

Conference calls typically connect people through a conference bridge, which is a server or other network element that can service multiple calls simultaneously. Many companies have their own bridge or can contact a service provider for conference call hosting. Many conferencing systems require a log in number and/or a personal identification number (PIN) in order to access the conference system. This is a safeguard in order to protect the services and information that is being offered through the teleconferencing system.

Generally, conference calls have two types of participants, moderators and attendees. Typically, a moderator schedules the time and date of the meeting and prepares the content for the meeting. Attendees can either view the presentation or can collaborate in an interactive setting, depending on the capabilities and nature of the program.

One disadvantage of the conventional systems is that, oftentimes, extensive planning is needed for a moderator to plan a conference call. The moderator must set up a time and date of the meeting, as well as prepare how the conference call will be facilitated. Moderators must also ensure that either a) all participants have the information necessary in order for them to dial in to the conference call (e.g. dial in conference calling), or b) that the system has all of the contact information necessary to reach all of the participants (e.g. adhoc conference calling).

As such, there is a need in the industry to provide a system that simplifies the work of a moderator. Furthermore, there is a need in the industry to minimize the amount of information that a moderator must retain in order to facilitate a conference call.

The present disclosure contemplates a new and improved method for resolving the above-referenced difficulties and others.

### SUMMARY OF THE DISCLOSURE

A method and system for remote generation of a conference call is provided.

In one aspect of the presently described embodiment, a method for remote generation of a conference call comprises receiving and initiating a transmission from a user, establishing one or more communication paths based on the initiating transmission, and connecting the established communication paths to form a conference call.

In another aspect of the presently described embodiments, receiving the initiating transmission includes receiving and SMS.

In another aspect of the presently described embodiments, the receiving and initiating transmission includes receiving an email.

In another aspect of the presently described embodiments, the method further includes verifying that the user is a subscriber.

In another aspect of the presently described embodiments, the method further includes replying to said user that a conference call has been formed.

In another aspect of the presently described embodiments, the method further includes adding a list of participants through voice activation.

In another aspect of the presently described embodiments, the receiving of the initiating transmission including receiving a list of conference call participants.

In another aspect of the presently described embodiments, the method includes implementing a “find me” feature.

In another aspect of the presently described embodiments, the method includes receiving instructions dictating when the conference call should be formed.

In another aspect of the presently described embodiments, the initiating transmission includes access codes for the conference call.

Further scope of the applicability of the present disclosure will become apparent from the detailed description provided below. It should be understood, however, that the detailed description and specific examples, while indicating preferred embodiments of the disclosure, are given by way of illustration only, since various changes and modifications within the spirit and scope of the disclosure will become apparent to those skilled in the art.

### DESCRIPTION OF THE DRAWINGS

The presently described embodiments exist in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 illustrates a portion of the communications network including a public network and exchange and conference bridge system.

FIG. 2 illustrates a portion of the communications network of FIG. 1 diagrammatically expanded with additional servers.

FIG. 3 is a flow chart illustration of the method according to the present disclosure.

FIG. 4 illustrates the server module according to an embodiment of the present disclosure.

### DETAILED DESCRIPTION OF THE PREFERRED EMBODIMENTS

The presently described embodiments enable a user to generate a conference call with the use of an SMS or e-mail message. Through such techniques, a user will no longer be required to retain such information as a designated bridge number or conference participant contact information.

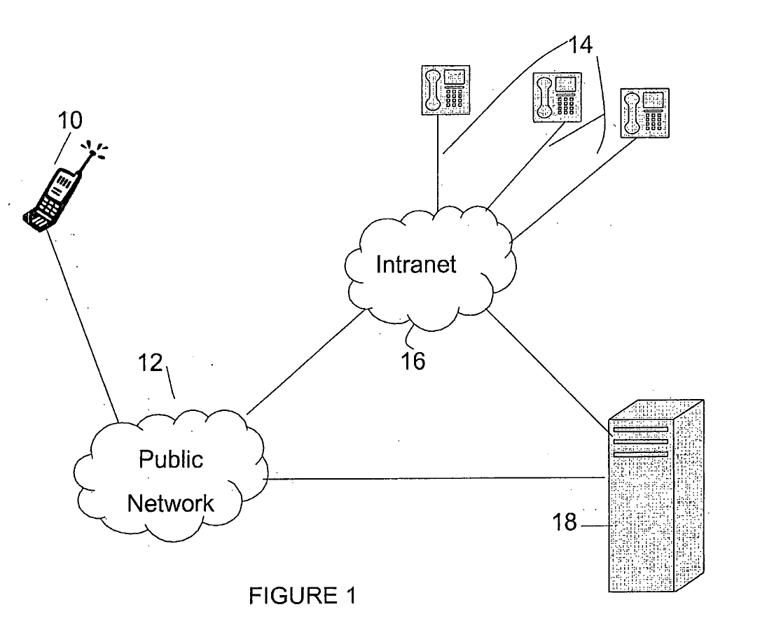

Referring now to the drawings wherein the showings are for purposes of illustrating the preferred embodiments of the disclosure only and not for purposes of limiting same, FIG. 1 provides a view of a system into which the present disclosure embodiments may be incorporated. A communication network infrastructure 1 is shown generally. The communication network infrastructure 1 includes a communication device 10, a public network 12, an exchange 16, a conference bridge system 18 and a connection to participants 14. Various other network configurations are also contemplated and would suffice to implement the techniques described herein.

In operation, as described in greater detail below, the presently described embodiment includes a method for remote generation of a conference call. The method includes receiving and initiating transmission from a user communication device 10, establishing one or more communication paths based on said initiating transmission and connecting the established communications paths to form a conference call.

Still referring to FIG. 1, the communication device 10 is shown as a mobile phone. However, it should be appreciated that the communications device 10 could be take a variety of forms. For example, the communications device 10 could be a lap top computer, a desk top computer, a Wi-Fi phone, etc. The communications device 10 sends an initiating transmission through a corresponding public network 12 to a conference bridge system or server 18. This initiating transmission can be sent in a variety of manners. For example, it can be sent through short messaging systems (SMS), an email message, or a variety of other communication elements.

The public network 12 is primarily operative as a support system in which the initiating transmission can be sent. The public network can be a public switch telephone network (PSTN), an internet network, a cellular or other wireless network, a hard wired network, or any other network capable of carrying the initiating transmission.

The conference bridge system or server 18 receives the initiating transmission, through a variety of sequences which is described in further detail below. The conference bridge server 18 processes the initiating transmission, then uses the information in the initiating transmission in order to determine the parameters of the conference call. The conference bridge server 18 then communicates the conference call through exchange 16. Through the exchange 16, users share a certain number of lines for making telephone calls. The exchange 16 can be a variety of different systems. For illustrative purposes, the exchange 16 is shown as an intranet system, however, the exchange 16 could be a private branch exchange (PBX), a Centrex system or the internet. In one embodiment of the presently described embodiments, the conference bridge system even sets up a variety of outside lines. In this instance, an exchange is not necessary. However, exchanges are often used because it is usually less expensive than connecting an external phone line for every phone line in the user's network. In addition, it is easier to call someone within an exchange because it is typically only necessary to dial three or four digits.

The exchange 16 connects to the participants lines which are shown as telephones 14. However, it should be appreciated that a participant may connect with the conference call through a variety of methods, including, but not limited to a computer, a PDA device, a voice over internet protocol (VoIP) telephone, cellular phone, etc. The exchange 16 can also connect back to the user. Often, this is the case because the user is an important part of the conference call. For example, the user (the person who sent the initiating transmission) is, in many instances, the moderator of the conference call.

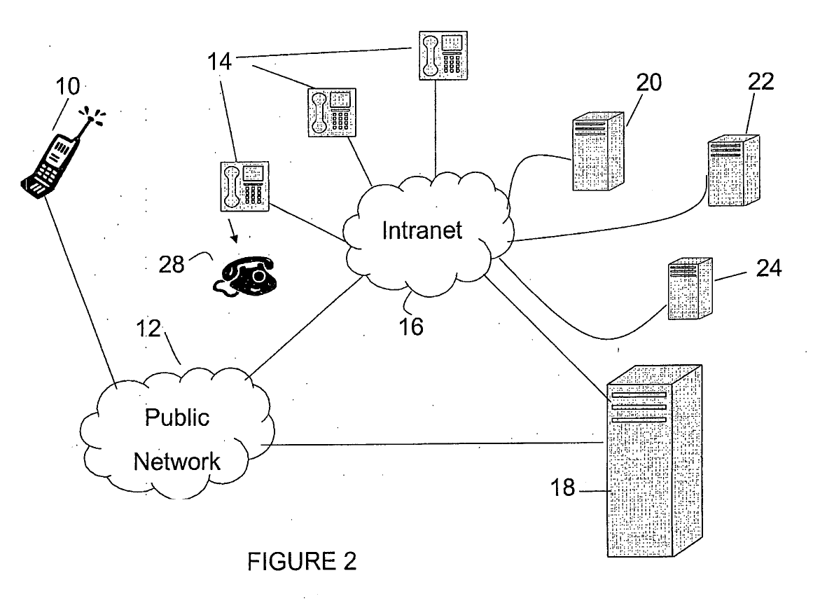

Referring now to FIG. 2, in this embodiment, the example communications network infrastructure is expanded and shown in further detail. This embodiment further includes a directory server 24, a messaging server 22, an email server 20 and a participant's second line 28.

The messaging server 22 prompts callers to leave messages for individuals. The messaging server 22 also records the voice mails when individuals are not available for calls. In one embodiment of the proposed system, the messaging server 22 may be used to record the conference call when the individual associated with the server's mailbox cannot attend. In some instances, the messaging server 22 may record the conference call for other purposes, possibly to study at a later time.

FIG. 2 also discloses a directory server 24. A directory server stores the company's employees contact information, as well as any other contact information the company may need, for example, suppliers or customers and/or client's contract information. The directory server 24 can serve a variety of purposes concerning setting up a conference call. The directory server 24 may be used to look up a participant's email address and/or phone number. The directory server 24 can also facilitate in contacting a proposed participant. In this respect, a user does not need to know all of the participant's contact information. In the present embodiment, the directory server 24 can be accessed through the internet; however, it should be appreciated that a variety of other components, for example, the conference bridge server 18, the intranet 16, the public network 12, etc. can access, and/or communicate with the directory server 24.

The email server 20 can be used to store prospective participants' email addresses and deliver messages to these prospective participants electronically. Similar to the directory server 24, a corporate email server 20 can also be accessed through the intranet and/or internet. Furthermore, the email server 20 can also be supported by the conference bridge server 18.

It should be appreciated that the corporate email server 20, messaging server 22 and directory server 24 could all be embodied in one device. They could also be their own separate devices. Furthermore, they could each be implemented within in the intranet system 16, conference bridge server 18 or in the internet itself 12.

FIG. 2 also illustrates a participant's second line 28. This second line 28 can be accessed whenever a first line 14 is insufficient. There are many reasons why a first line would be insufficient. These reasons include, but are not limited to, poor quality of service (QoS), a lack of reception, a lack of the participant being physically near the phone, and/or a lack of services for, the phone. Once it is determined that the participant's first line 14 is not acceptable for whatever reason, the participant's second line 28 can be accessed. In this instance, the second line 28 can be accessed through “find me” features, call forwarding, etc.

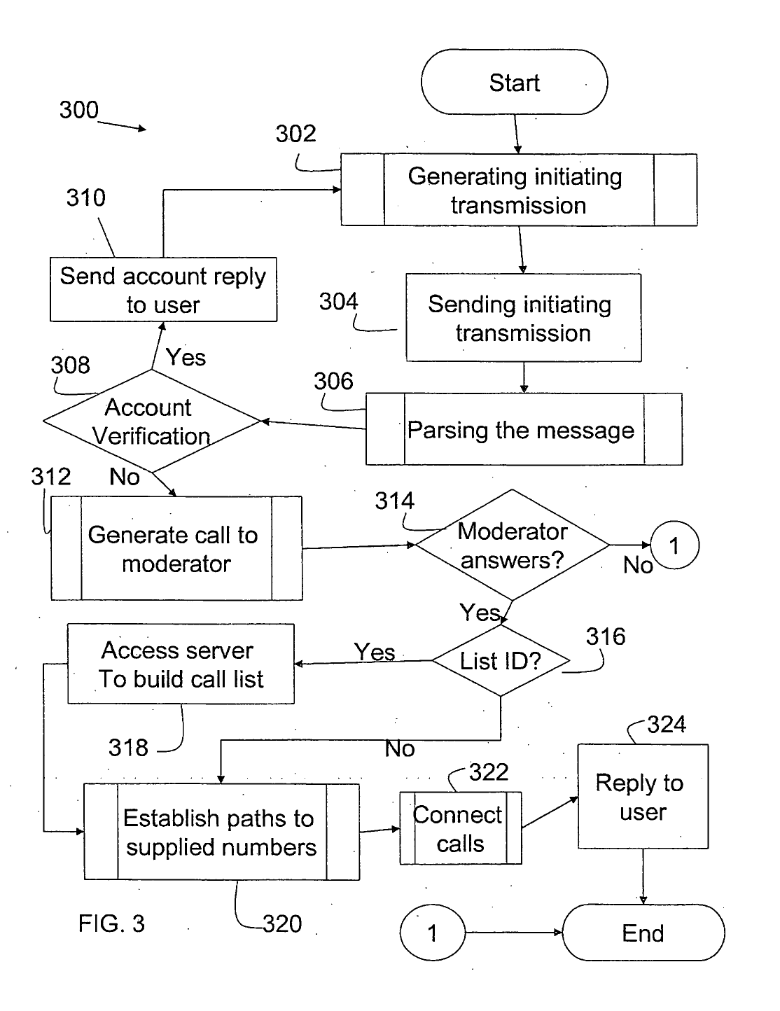

Referring now to FIG. 3, a method of remote generation of a conference call is shown generally at 300. It should be understood that the method may be implemented using a variety of software and hardware configurations. In one form, the software implementing the method of FIG. 3 resides in the conference bridge system. In another form, the software implementing the method of FIG. 3 resides in the intranet and/or exchange system. The software may also be distributed among the suitable network elements.

As shown, the method 300 includes generating an initiating transmission 302. This initiating transmission can be an email or an SMS message with messaging text. The text could include a variety of different formats. In one embodiment, the text or email message would include the time and/or date of the conference call. The text message could further include the participants contact information. In this regard, the contact information could include email addresses and/or telephone numbers, including cell phone numbers, Voice over Internet Protocol (VoIP) phone numbers, etc. The message could include a number in which to route the participants' calls. The message could further include a password value, a start time, an end time, a secondary list of phone numbers, voice mail number to send to if the participant does not answer.

The method 300 continues with the text initiating transmission being sent to a receiving system 304. Sending SMS and e-mail messages is well known in the art, therefore, the message can be sent using any known means. The message could be sent over a public network which could include a public switch telephone network, a VoIP network, the intranet, etc.

The message is then parsed in order to act on it. Parsing the message includes dividing the message into its components with respect to a predetermined format. Acting on the message could include opening up a java application in which to generate the contact information for the participants. It could also include replying to the sender, possibly in the same format in which it received the message in order to query for a list of participants and/or the participants' contact information. One benefit of this method is that it is not necessary for the user to know and/or remember any information about how to access the conference bridge. The user would simply send an SMS or email message or some other initiating transmission to the system and the system would act upon that message.

Another step in the method 300 is account verification (at 308). If account verification is necessary then the conference bridge system can send out a reply to the user from the conference bridge system's address. However, if account verification is not necessary, then the conference bridge system would simply generate a call to a moderator (at 312). If the moderator answers (at 314), then the system would determine if a list or list ID is included in the initiating transmission (at 316). If the moderator does not answer, the call will end and a conference call will not take place.

The method continues with the conference bridge server building a call list if a list or list identification is included (at 318). In this instance, the bridge system will access the directory server in order to build a call list based on the list identifications. For example, the initiating transmission could include a list of names that are contained within the directory server. The conference bridge system would access the directory server in order to get contact information associated with the listed names. In another embodiment, the initiating transmission would include a list of groups (for example, associates or directors, etc.). In this instance the conference bridge system would access the directory server in order to define these groups and obtain contact information for the individuals in the group(s). In another embodiment, the system may access the directory and display it to the user in an application. In this case, the user could go through the system personally and find the individuals that will be added to the conference call. In another embodiment, the list identification is not included in the initiating transmission. In this instance, the conference bridge server may query the user or the moderator which person to contact. In another instance, there is a default list of persons that will be contacted. In yet another embodiment, a list may have been predetermined prior to the user sending the initiated transmission. As an alternative the bridge system can also access the email server 20 to build a call list.

The system then places calls to the supplied numbers (at 320). The supplied numbers could be listed in the initiating transmission or the list identification could be used to access the system in order to generate a list. Those skilled in the art will appreciate that there a numbers of methods known in art that enable the system to access a server with a database to interpret a list identification and build a call list. Through either method, the call list will be accessed and used in order to place the call.

The method then includes connecting the calls through a communication path (at 322). The communication paths can vary depending on the system's qualifications. The communication path could be the intranet, VoIP lines, etc. The communication path could even include accessing a chat room in order for the conference to take place via instant messaging. Finally, the method 300 includes replying to the user that the process has been completed successfully. This will signal to the moderator that the connections are made and the conference call can take place.

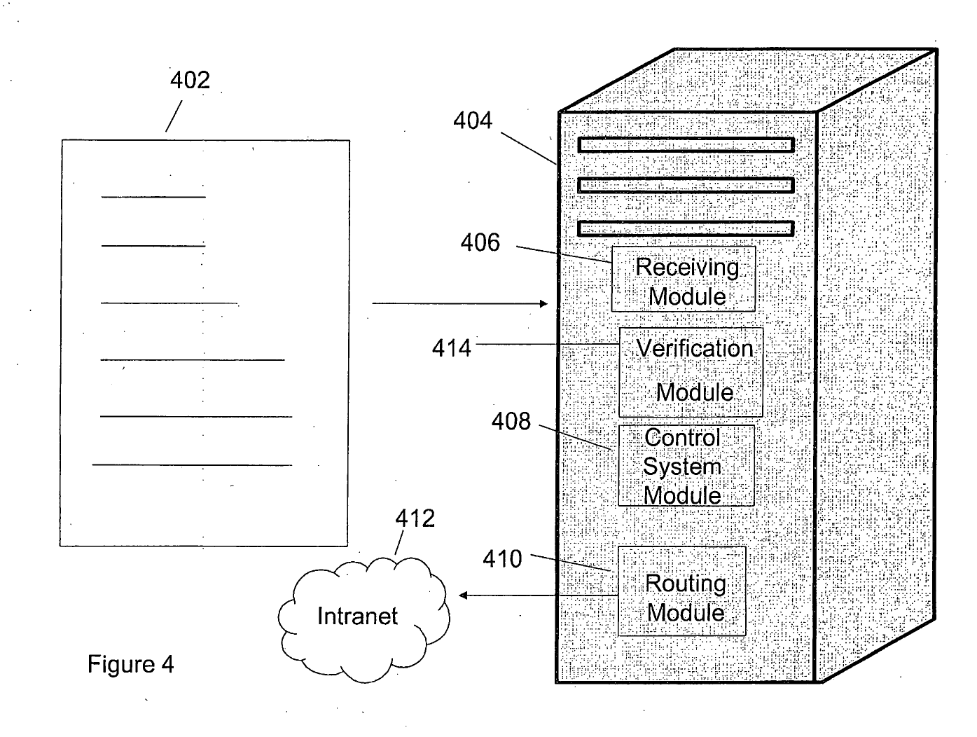

Now, referring to FIG. 4, the system may include four modules. As shown the system includes a receiving module 406, a verification module 414, a control system module 408, and a routing module 410. The system further includes a conference bridge system 404, an initiating transmission 402, and an exchange 412 which is visualized through a communication cloud representing the intranet. The receiving module 406 receives the initiating transmission 402, which is sent to the conference bridge system 404 (e.g. shown at FIG. 3, 304). As noted above, the initiating transmission could be a variety of different media and the receiving module 406 is configured to accept these different types of media.

The control system module 404 is configured to parse the initiated transmission 402 into components in order to determine the parameters for the potential conference call (e.g. FIG. 3, 306). One method of accomplishing this step is the control system module 404 dividing the initiating transmission into its different components. These components could include the phone number for the moderator, the number/E-mail addresses of invited individuals, the unified messaging account in which to charge, the number to route calls, the list of numbers to allow to be forwarded and/or the indicator for a predetermined list, an authentication or a password value, a start time, an end time, a list of numbers to replace and/or a voice mail number to send the call to if forward isn't answered or if the call cannot be forwarded, etc.

A routing module 410 is adapted to set up one or more communication paths based upon how many lines are participating in the conference call. These paths can be set up through a variety of different methods including VoIP paths, intranet paths, etc. These paths are also set up through an exchange or in one embodiment, through the intranet 412 (e.g. FIG. 3, 320).

A verification module is also shown in FIG. 4. The verification module 414 is used in order to verify that the moderator should have access to the conference bridge system (e.g. FIG. 3, 308). The verification module could include a system designed to accept access codes. The verification module 414 could also include a caller identification system to insure that the call is originating from a pre-approved line. The verification module 414 could also have access to the directory server in order to insure that the moderator and participants are members of the pre-approved community. In another embodiment, the verification module 414 would have the means to communicate with the moderator in order to query for this type of information.

The above description merely provides a disclosure of particular embodiments of the disclosure and is not intended for the purposes of limiting the same thereto. As such, the disclosure is not limited to only the above-described embodiments. Rather, it is recognized that one skilled in the art could conceive alternative embodiments that fall within the scope of the disclosure.

We claim:

1. A method of remote generation of a conference call comprising:
receiving an initiating transmission from a user;
establishing one or more communication paths based on said initiating transmission; and
connecting said established communication paths to form a conference call.

2. A method according to claim 1, wherein receiving said initiating transmission includes receiving an SMS message.

3. A method according to claim 1, wherein receiving said initiating transmission includes receiving an E-mail.

4. A method according to claim 1 further comprising verifying that said user is a subscriber.

5. A method according to claim 1 further comprising a replying to said user that said conference call has been formed.

6. A method according to claim 1, wherein receiving said initiating transmission includes receiving a list of conference call participants.

7. A method according to claim 1, further comprising adding a list of participants through voice activation.

8. A method according to claim 1, further comprising implementing find me features.

9. A method according to claim 1, wherein receiving said initiating transmission includes a set of instructions dictating when said conference call should be formed.

10. A method according to claim 1, wherein receiving said initiating transmission includes access codes for said conference call.

11. A system for remote generation of a conference call comprising:
a messaging server configured to receive a transmission requesting the activation of a conference call;
a control system module configured to parse said transmission into components in order to determine parameters for said conference call; and
a routing module that initiates one or more conference circuits in accordance with said transmission.

12. A system according to claim 11 further comprising a directory server that includes a database of contact information.

13. A system according to claim 11 further comprising a verification module configured to authenticate said transmission.

14. A system according to claim 11, wherein said routing module initiated said conference circuits through an intranet system.

15. A system according to claim 11, wherein said routing module initiated said conference circuits through a private branch exchange.

16. A system according to claim 11, wherein said routing module initiated said conference circuits through a centrax.

17. A method for the remote generation of a conference call comprising:
receiving a short messaging system message from a user requesting the initiation of a conference call;
verifying said short messaging system message;
generating a first call to a moderator;
establishing one or more communication paths between said first call and at least one participant based on said short messaging system message;
connecting said established communication paths to form a conference call; and
replying to said user that said conference call has been established.

18. A system of remote generation of a conference call comprising:
a means for receiving an initiating transmission from a user;
a means for establishing one or more communication paths based on said initiating transmission; and
a means for connecting said established communication paths to form a conference call.

19. A system according to claim 18, wherein said initiating transmission is a short messaging system message.

20. A system according to claim 18, wherein said initiating transmission is an e-mail message.
